(19) United States
(12) Patent Application Publication
(10) Pub. No.: US 2021/0274701 A1
(43) Pub. Date: Sep. 9, 2021

(54) SEED STORAGE DEVICE, COMPLETED SEED KIT, AND METHOD OF STORING AND PLANTING SEEDS

(71) Applicant: Aspara Limited, Hong Kong (CN)

(72) Inventors: Kwong Wai LEUNG, Hong Kong (CN); Sze Yin Yvonne CHAN, Hong Kong (CN)

(21) Appl. No.: 16/812,155

(22) Filed: Mar. 6, 2020

(51) Int. Cl. A01C 7/02

(52) U.S. Cl. CPC A01C 7/02

(57) ABSTRACT

A seed storage device comprising a plurality of pods connected sequentially. Each pod is adapted to store one or more seeds and adapted to be breachable to facilitate releasing the seeds to a planting location. An associated method of storing seeds comprising placing one or more seeds into a pod of the seed storage device, and an associated method of planting seeds using the seed storage device, are also provided. A completed seed kit comprising the seed storage device with one or more seeds stored in one or more of the pods is also provided.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### FIELD OF THE INVENTION

The invention relates to seed storage devices, completed seed kits, and methods of storing and planting seeds. The invention is herein described by reference to storing and planting seeds in relatively small quantities such as in the context of smart indoor grow boxes and other apparatuses for growing plants at home, but the invention is not limited to these applications.

### BACKGROUND OF THE INVENTION

Apparatuses for growing plants at home such as vegetables, fruits, herbs, and flowers are increasingly popular as consumers seek healthy diets and lifestyles. In particular, consumers seek food grown without undesirable chemicals, such as organic food, and food cultivated in an environment known and controlled by the consumer.

Apparatuses for growing plants at home come in a number of forms. These include simple planters in the form of pots and planter boxes. There are also home hydroponic cultivators, including those using peat moss, sphagnum, sponge, or other growing media into which plant seeds are planted. These apparatuses also include home growing systems that include hydroponic cultivators with electronically controlled lighting, sensors, monitoring, water reticulation and circulation.

Typically, seeds are purchased pre-planted in growing media, and often in the form of pods or baskets. In some hydroponic systems, these pods or baskets fit into complementary receptacles in the hydroponic system. One disadvantage of this method is that there is less flexibility since a consumer is limited to the range and availability of pre-planted pods or baskets. Also, many hydroponic system only accept compatible pods or baskets. Furthermore, the pods or baskets often have a limited shelf-life after which the seeds pre-planted in the pods or baskets are unviable, especially if the pods or baskets are not sealed or cannot be sealed. Pre-planted pods or baskets can also be expensive to manufacture.

Seeds can also be purchased in packages such as sachets. In this case, the packages are opened by a consumer and the seeds are planted by the consumer. The seeds can be planted into growing media such as soil in planter pots or boxes, or peat moss, sphagnum, sponge in pods or baskets for hydroponic systems. One disadvantage of this method is that it is a tedious task for a consumer to plant the seeds by hand. The seeds are usually quite small and the consumer will need to use tools such as forceps or tweezers and carefully plant the seeds in the correct location in the growing media. Another disadvantage is that often not all of the seeds in a package are planted at once. This means that the seeds remaining in the package will be exposed to the external environment which will significantly decrease the period of viability of the remaining seeds.

It is an object of the present invention to overcome or ameliorate at least one of the disadvantages of the prior art, or to provide a useful alternative.

### SUMMARY OF THE INVENTION

Embodiments of the present invention in a first aspect provide a seed storage device comprising a plurality of pods connected sequentially, each pod adapted to store one or more seeds and adapted to be breachable to facilitate releasing the seeds to a planting location.

Embodiments of the present invention in a second aspect provide a method of planting seeds using a seed storage device as described above, the method comprising:

breaching one of the pods; and

releasing the seeds to a planting location.

Embodiments of the present invention in a third aspect provide a method of storing seeds, the method comprising placing one or more seeds into a pod of the seed storage device as described above. In one embodiment, each pod is formed by a cavity in a first substrate and a second substrate covering the cavity, and the method comprises: placing one or more seeds into the cavity; and covering the cavity with the second substrate. In another embodiment, each pod is formed by a cavity in a first substrate and a second substrate covering the cavity, and the method comprises: forming the cavity in a first substrate; placing one or more seeds into the cavity; and covering the cavity with the second substrate.

Embodiments of the present invention in a fourth aspect provide a completed seed kit comprising a seed storage device as described above, and one or more seeds stored in one or more of the pods.

Embodiments of the present invention in a fifth aspect provide a smart indoor grow box comprising a completed seed kit as described above.

Other features and embodiments of the present invention can be found in the appended claims.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### DESCRIPTION OF THE DRAWINGS

Preferred embodiments in accordance with the best mode of the present invention will now be described, by way of example only, with reference to the accompanying figures, in which the same reference numerals refer to like parts throughout the figures unless otherwise specified, and in which:

FIG. 1 is a top perspective view of a seed storage device in accordance with an embodiment of the present invention;

FIG. 2 is a side perspective view of the seed storage device of FIG. 1;

FIG. 3 is a top view of the seed storage device of FIG. 1;

FIG. 4 is a cross-sectional view of the seed storage device of FIG. 1 as indicated by section line A-A shown in FIG. 3;

FIG. 5 is a bottom perspective view of a seed storage device in accordance with another embodiment of the present invention;

FIG. 6 is a top perspective view of the seed storage device of FIG. 5;

FIG. 7 is an end view of the seed storage device of FIG. 5;

FIG. 8 is a bottom view of the seed storage device of FIG. 5;

FIG. 9 is a cross-sectional view of the seed storage device of FIG. 5 as indicated by section line B-B in FIG. 8;

FIG. 10 is a side view of the seed storage device of FIG. 5.

FIG. 11 shows a seed storage device in use in accordance with an embodiment of the present invention in which a user is releasing seeds from a pod of the seed storage device that has been cut open by the user;

FIG. 12 shows a seed storage device in accordance with an embodiment of the present invention in which the seed storage device is in the form of a tape wound on a reel;

FIG. 13 is a top view of a seed storage device in accordance with another embodiment of the present invention; and

FIG. 14 is a top perspective view of the seed storage device of FIG. 13 in which a pod has been cut open and seeds are being released from the pod to a planting location.

### DETAILED DESCRIPTION OF PREFERRED EMBODIMENTS OF THE INVENTION

With reference to the figures, there is provided a seed storage device 1 comprising a plurality of pods 2 connected sequentially. Each pod 2 is adapted to store one or more seeds 3 and adapted to be breachable to facilitate releasing the seeds to a planting location 4.

Each pod 2 can be breachable by one or more of the following: cutting; bursting; deforming; tearing; folding; peeling. Advantageously, each pod 2 has a shape such that when breached forms an opening 5 that directs the seeds 3 into a predetermined direction to facilitate releasing the seeds 3 to a planting location 4.

A “pod” is simply any structure, formation, or anything else that houses, contains, or holds the seeds 3. In other words, the term “pod” is to be interpreted broadly, and other than that broad interpretation, no further specific limitations are to be read into the term “pod”. As such, a “pod” can variously be described as a “container”, “receptacle”, “housing”, “pocket”, “cell”, “blister”, or any other like term.

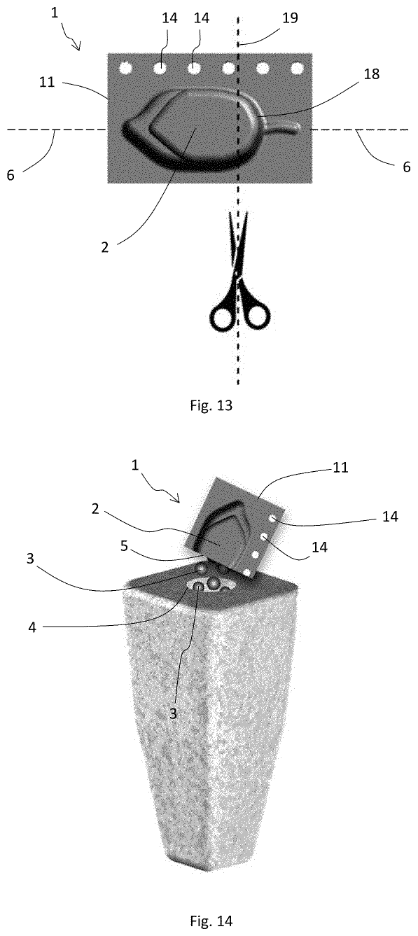

In one example, as best shown in FIGS. 13 and 14, the pods 2 are arranged sequentially along a longitudinal axis 6, and each pod 2 has an end 18 and is adapted to be cut across the end 18 in a direction 19 across the longitudinal axis 6 to breach the pod 2 and facilitate releasing the seeds 3 to the planting location 4. It has been found that cutting a pod 2 across the end 18 in a direction 19 across the longitudinal axis 6 to breach the pod 2 creates an opening 5 that facilitates a relatively free flow of the seeds 3 out of the opening 5 into a predetermined direction to direct the seeds 3 to the planting location 4.

In another example, the pods 2 are arranged sequentially along a longitudinal axis 6, and each pod 2 has a side 7 and is adapted to be cut along the side 7 at an angle 8 towards the longitudinal axis 6 to breach the pod 2 and facilitate releasing the seeds 3 to the planting location 4. It has been found that cutting a pod 2 along the side 7 at an angle 8 towards the longitudinal axis 6 facilitates a relatively free flow of the seeds 3 out of the opening 5 into a predetermined direction to direct the seeds 3 to the planting location 4. Cutting the pod 2 in this way is also easy for a user to perform. The side 7 can be either side of the pod 2 that extends in a direction along the longitudinal axis 6. This means that it is equally convenient for right-handed and left-handed users to cut the pod 2 as described.

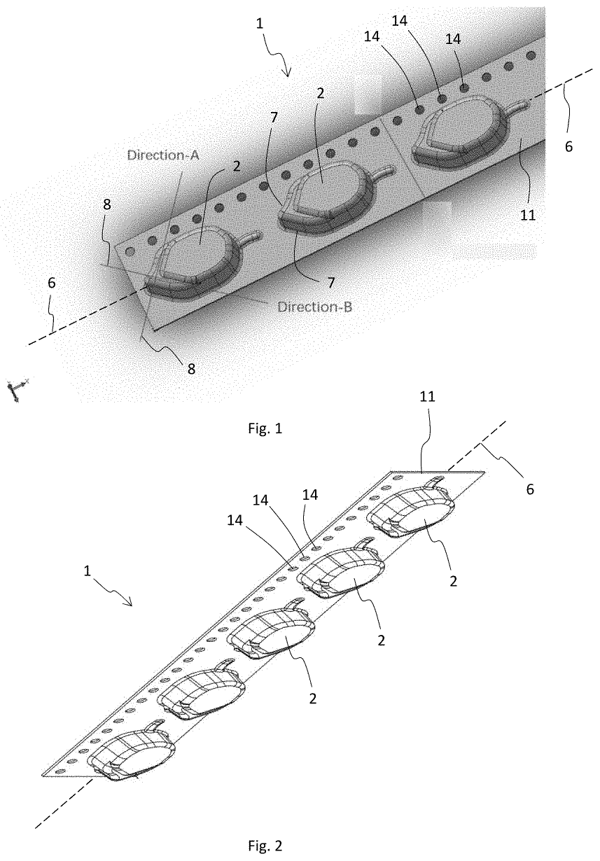

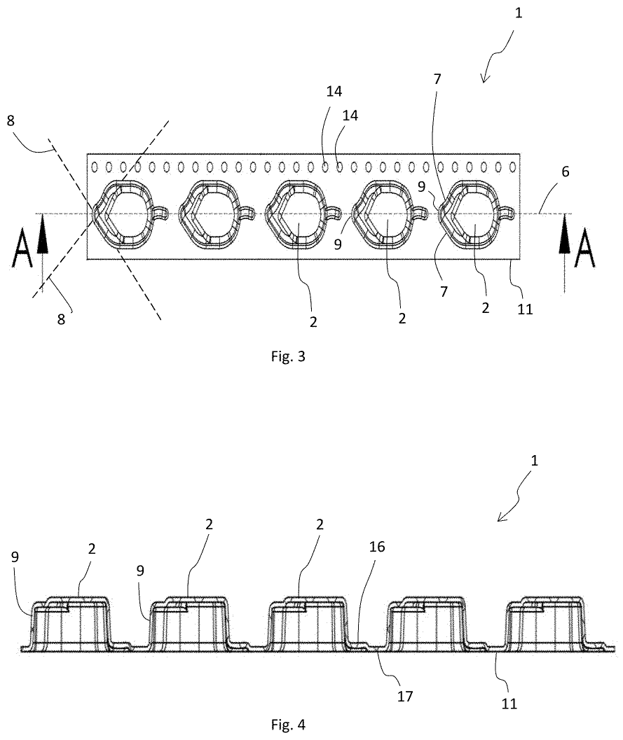

In yet another example, as best shown in FIGS. 1 to 4, the pods 2 are arranged sequentially along a longitudinal axis 6, and each pod 2 has a tapered end 9 with at least a side 7 tapering towards the longitudinal axis 6. In this case, each pod 2 is adapted to be cut along the side 7 towards the longitudinal axis 6 to breach the pod and facilitate releasing the seeds 3 to a planting location 4. Similar to the example above, the pod 2 is cut along the side 7 at an angle 8 towards the longitudinal axis 6 since the side 7 tapers towards the longitudinal axis 6. All of the advantages described for the above example apply to this example as well, including the free flow of seeds 3 into a predetermined direction and the ease with which a user can perform the cut. Also, the tapered end 9 can be formed with two sides 7 tapering towards the longitudinal axis 6. As above, this means that it is equally convenient for right-handed and left-handed users to cut the pod 2 as described. A further advantage is that a user can use the tapered sides 7 as a guide for cutting the pod 2, enhancing the ease of use. The tapered sides 7 can be tapered to an optimum angle for facilitating the free flow of seeds 3 into a predetermined direction, and as such will guide the user into cutting the pod at this optimum angle.

In another example, the pods 2 are arranged sequentially along a longitudinal axis 6, and each pod 2 has a side 7 with at least a portion of the side 7 tapering away from the longitudinal axis 6. In this case, each pod 2 is adapted to be cut such that a remaining portion of the side 7 tapers away from the longitudinal axis 6 to breach the pod 2 and facilitate releasing the seeds 3 to the planting location 4. It has been found that having a remaining portion of the side 7 tapering away from the longitudinal axis 6 facilitates a relatively free flow of the seeds 3 out of the opening 5 into a predetermined direction to direct the seeds 3 to the planting location 4.

Instead of being cut along the side 7, the seed storage device 1 can include perforations along the side 7 so that a user can manually tear the pod 2 open along the perforation.

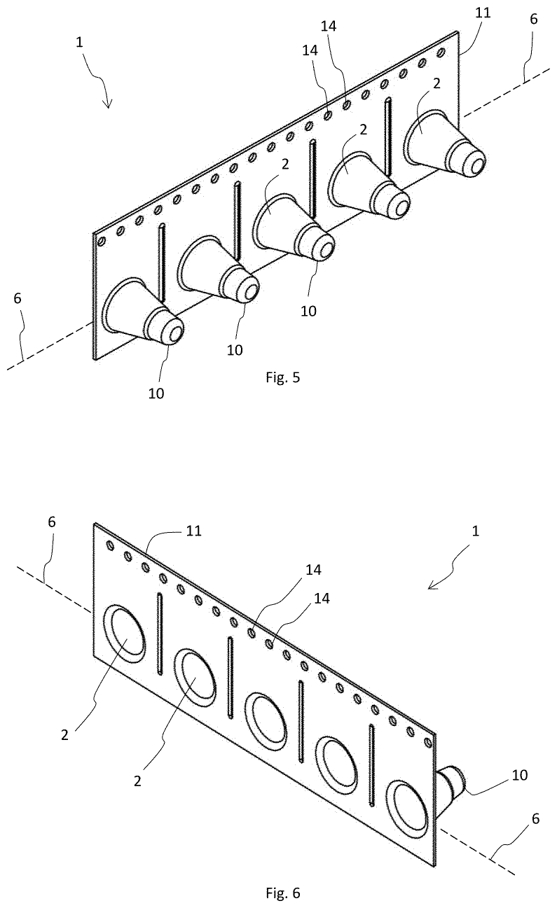

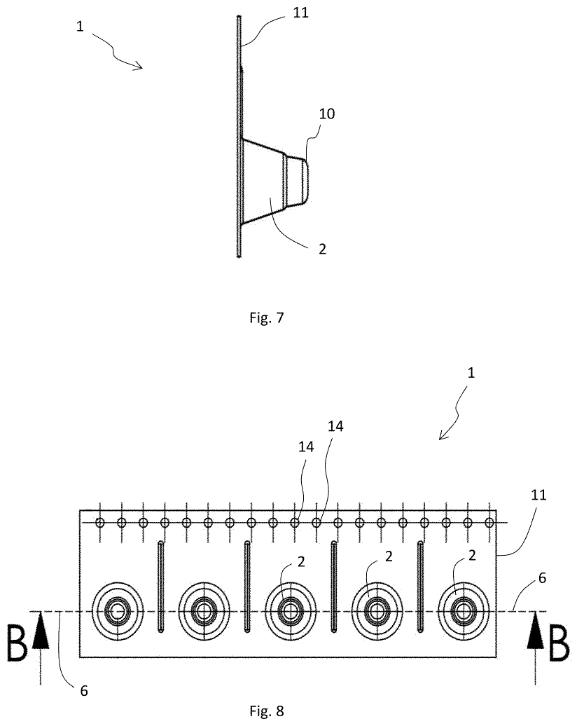

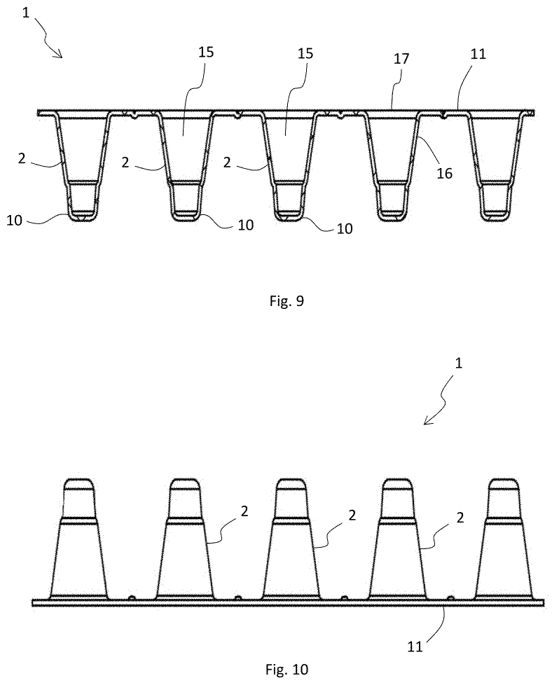

In a further example, as best shown in FIGS. 5 to 10, the pods 2 are arranged sequentially along a longitudinal axis 6, and each pod 2 extends away from the longitudinal axis 6 to a distal end 10 which is adapted to be cut to breach the pod 2 and facilitate releasing the seeds 3 to the planting location 4. Each pod 2 can taper towards the distal end 10 so that the distal end is relatively smaller than the rest of the pod 2. This facilitates cutting of the distal end 10, and also results in a funnel-type configuration for the pod 2 which assists in release of the seeds 3 out of the opening 5 into a predetermined direction to direct the seeds 3 to the planting location 4.

It is appreciated that there are other embodiments employing other methods to breach each pod 2. An example of tearing the side 7 was described above. In another example, each pod 2 is in the form of a blister and this is breached by bursting the blister open. Each pod 2 can also be perforated and is breached by folding along the perforations.

In an advantageous embodiment, the seed storage device 1 is in the form of a tape, strip, or film 11, with the pods 2 arranged sequentially along the tape, strip, or film 11. The tape 11 can be adapted so that it can be wound into a tape reel 12 for convenient and compact storage. This is best shown in FIG. 12. The tape reel 12 can be wound or mounted onto a housing 13. The tape 11 can have a plurality of notches 14 formed in a perimeter portion of the tape 11 to facilitate winding of the tape 11 or positioning of the tape 11 such as during manufacture. Having the pods 2 forming a tape 11 that can be wound into a tape reel 12 is especially advantageous for the manufacture, storage, and transportation along a supply chain, especially in respect of seeds divided into small quantities contained in separate pods.

Each pod 2 is typically sealed against an external environment to minimise spoilage of the seeds 3. This maximises the period of viability of the seeds 3.

In one embodiment, each pod 2 is formed by a cavity 15 in a first substrate 16 and a second substrate 17 covering the cavity 15. The cavity 15 can be formed by applying one or more of the following to the first substrate: deforming; moulding; embossing; blistering; stamping; and any other suitable forming process. For example, the first substrate 16 can be moulded to form a plurality of cavities 15 spaced sequentially along the first substrate. The moulding process can be, for example, vacuum moulding or blow moulding. After placing seed 3 into each cavity 15, the second substrate 17 is then placed against the first substrate 16 to cover the cavities 15 thereby forming the pods 2.

The planting location 4 can be on any growing media for cultivating plants from seeds including but not limited to soil, peat moss, sphagnum, or sponge. The growing media can be located in planter pots, planter boxes, hydroponic cultivators or systems, including those designed for home use. In particular, the planting location 4 can be on growing media in growing pods, baskets, or trays in hydroponic systems.

The seed storage devices 1 of the present invention are well suited for storing small quantities of seeds in individually sealed pods 2. This makes them particularly well suited to home growing systems where small quantities of seeds are required for each planting. In particular, this means that only one pod 2 needs to be breached or opened at each planting to plant the required number of seeds for that planting, while the remaining seeds are still sealed inside the remaining unbreached pods 2. This maximises the viability of the remaining seeds. Typically, only 1 to 10 seeds are required at each planting depending on the plant species. Therefore, each pod 2 only needs to contain 1 to 10 seeds. Advantageously, this minimises wastage, spoilage, and the associated costs.

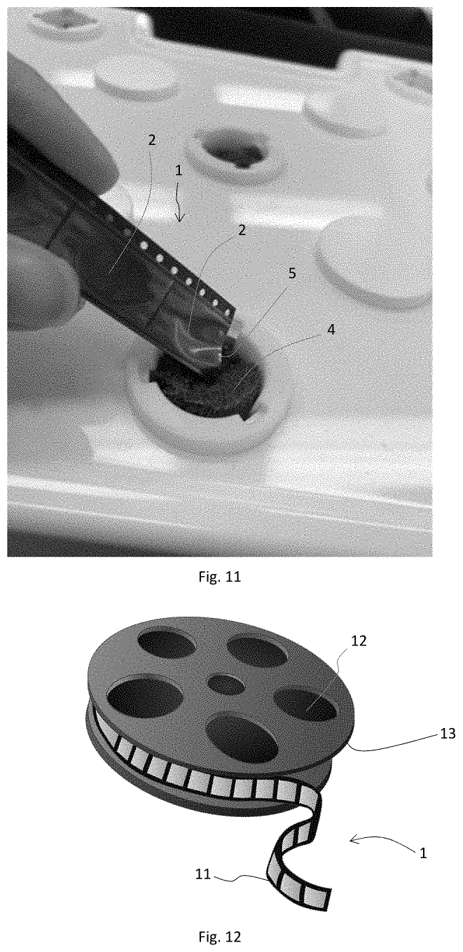

The seed storage devices 1 of the present invention are also well suited for facilitating releasing the seeds to a planting location 4. In particular, the storage devices 1 are well adapted for directing seeds into a predetermined direction to facilitate releasing the seeds to a planting location 4. This is particularly advantageous for planting seeds in home growing systems where the planting location 4 can be a small area requiring precision in placing the seeds into the planting location 4. For example, the planting location 4 can be a small area of growing media in a pod or basket in a hydroponic system. No other tools, like forceps or tweezers, are required to place the seeds 3 correctly in the planting location 4. Thus, the task of planting the seeds 3 is no longer tedious or is much less tedious than prior methods. In particular, the user simply breaches a pod 2, by cutting, for example, to create an opening 5. The user then places the opening above the planting location 4, and then pours the seeds inside the pod 2 onto the planting location 4. If required, the user can also tap the seed storage device 1 to encourage the flow of the seeds out of the opening 5. This is best shown in FIG. 11.

Once a pod 2 is cut and the seeds 3 contained therein are released, the tape 11 can be cut again to remove the remaining portion of the cut pod 2 leaving the next pod 2 ready for use at the next planting. Alternatively, the tape 11 comprises perforations between the pods 2 so that each pod 2 can be separated manually by a user by tearing along the perforations.

As can be readily appreciated from the above, the seed storage device 1 is not only for storing seeds, but can also be described as a seed planter or seed applicator. The seeds 3 can be any type of seed that germinates and is cultivated into any type of plant, including but not limited to vegetables, fruit, herbs, and flowers. This includes superfoods such as kale, goji berries, chia seeds, quinoa, beets, microgreens, wheatgrass, which are increasingly grown at home by consumers seeking healthy diets and lifestyles.

Embodiments of the present invention are particularly well suited to being in the form of completed seed kits for domestic or home indoor grow boxes or other home growing systems, including smart indoor grow boxes. Such smart grow boxes can incorporate smart water circulation systems, smart lighting systems, sensors, smart monitoring systems, networked connection, or other smart features. These home growing systems are typically designed to cultivate plants in relatively small volumes at a time. Traditional methods of supplying seeds include seeds pre-planted in growing media in pods or baskets and seeds supplied in sachets. However, such traditional methods have significant drawbacks and disadvantages as discussed above. In embodiments of the present invention in the form of completed seed kits, small quantities of seeds are stored in each individually sealed pod 2. These small quantities are the required quantities for each planting for which home growing systems such as indoor grow boxes are designed. Therefore, these completed seed kits provided by embodiments of the present invention are an ideal and natural component of indoor grow boxes and other home growing systems. Generally, one or more of seeds 3 are stored in one or more of the pods 2.

Embodiments of the present invention are also in the form of smart indoor grow boxes or other home growing systems comprising a completed seed kit such as those described above. As noted, the seed storage device 1 or completed seed kits as described above are an ideal and natural component of home growing systems such as smart indoor grow boxes. As such, embodiments of the present invention are also in the form of smart indoor grow boxes or other home growing systems that are packaged or sold with the seed storage device 1 or the completed seed kit incorporated as in integral component of the smart indoor grow boxes or home growing systems.

According to embodiments of another aspect of the present invention, there is provided a method of planting seeds 3 using the seed storage device 1 as described above. The method comprises breaching one of the pods 2, and releasing the seeds 3 to a planting location 4.

According to embodiments of a further aspect of the present invention, there is provided a method of storing seeds 3. The method comprises placing one or more seeds 3 into the pod 2 of the seed storage device 1 as described above. Where each pod 2 is formed by a cavity 15 in a first substrate 16 and a second substrate 17 covering the cavity 15, the method comprises placing one or more seeds 3 into the cavity 15, and covering the cavity 15 with the second substrate 17. Alternatively, the method can comprise forming the cavity 15 in the first substrate 16, placing one or more seeds 3 into the cavity 15, and covering the cavity 15 with the second substrate 17. Typically, covering the cavity 15 with the second substrate 17 includes sealing the cavity 15 against an external environment to minimise spoilage of the seeds 3. The cavity 15 can be formed by one or more of the following: moulding; deforming; blistering; stamping; and any other suitable forming process.

Other embodiments and features of these methods are clear from the foregoing description in relation to the seed storage device 1.

These methods are well suited to the automated manufacturing of seed storage devices. In particular, the steps of the methods described above can be easily automated. For example, an automated manufacturing machine or process can be adapted to place one or more seeds 3 into the pod 2 of the seed storage device 1 as described above. Similarly, where each pod 2 is formed by a cavity 15 in a first substrate 16 and a second substrate 17 covering the cavity 15, an automated manufacturing machine or process can be adapted to place one or more seeds 3 into the cavity 15, and cover the cavity 15 with the second substrate 17. Alternatively, an automated manufacturing machine or process can be adapted to form the cavity 15 in the first substrate 16, place one or more seeds 3 into the cavity 15, and cover the cavity 15 with the second substrate 17. In both cases, the automated manufacturing machine or process can also seal the cavity 15 against an external environment to minimise spoilage of the seeds 3. These automated manufacturing methods are facilitated by the features of the seed storage devices 1 according to embodiments of the present invention. For example, having the pods 2 arranged sequentially facilitates linear manufacturing processes which can be very quick and efficient. The pods 2 can be filled with the seeds 3 in quick linear succession along a processing line. Where each pod 2 is formed by a cavity 15 in a first substrate 16 and a second substrate 17 covering the cavity 15, each cavity 15 can be filled with the seeds 3 and then covered by the second substrate 17 in quick linear succession along a processing line. Alternatively, each cavity 15 can be formed in the first substrate 16, then filled with the seeds 3, and then covered by the second substrate 17 in quick linear succession along a processing line. Each cavity 15 can be formed by, for example, inline moulding or stamping along the processing line.

These automated manufacturing methods lead to many significant advantages. One advantage is that a large volume of seeds can be efficiently packaged into small and/or predetermined quantities in each pod 2. The seeds can also be packaged in a sterile environment or in an environment with limited human intervention to minimise the introduction of contaminants. The types and quantities of seeds can also be easily changed.

It is appreciated that the aforesaid embodiments are only exemplary embodiments adopted to describe the principles of the present invention, and the present invention is not merely limited thereto. Various variants and modifications can be made by those of ordinary skill in the art without departing from the spirit and essence of the present invention, and these variants and modifications are also covered within the scope of the present invention. Accordingly, although the invention has been described with reference to specific examples, it is appreciated by those skilled in the art that the invention can be embodied in many other forms. It is also appreciated by those skilled in the art that the features of the various examples described can be combined in other combinations.

It is claimed:

1. A seed storage device comprising a plurality of pods connected sequentially, each pod adapted to store one or more seeds and adapted to be breachable to facilitate releasing the seeds to a planting location.

2. A seed storage device according to claim 1 wherein each pod is breachable by one or more of the following: cutting; bursting; deforming; tearing; folding; peeling.

3. A seed storage device according to claim 1 wherein each pod has a shape such that when breached forms an opening that directs the seeds into a predetermined direction to facilitate releasing the seeds to the planting location.

4. A seed storage device according to claim 1 wherein the pods are arranged sequentially along a longitudinal axis, and each pod has an end and is adapted to be cut across the end in a direction across the longitudinal axis to breach the pod and facilitate releasing the seeds to the planting location.

5. A seed storage device according to claim 1 wherein the pods are arranged sequentially along a longitudinal axis, and each pod has a tapered end with at least a side tapering towards the longitudinal axis, and each pod is adapted to be cut along the side towards the longitudinal axis to breach the pod and facilitate releasing the seeds to the planting location.

6. A seed storage device according to claim 1 wherein the pods are arranged sequentially along a longitudinal axis, and each pod extends away from the longitudinal axis to a distal end adapted to be cut to breach the pod and facilitate releasing the seeds to the planting location.

7. A seed storage device according to claim 1 wherein each pod is sealed against an external environment to minimise spoilage of the seeds.

8. A seed storage device according to claim 1 wherein each pod is formed by a cavity in a first substrate and a second substrate covering the cavity.

9. A seed storage device according to claim 8 wherein the cavity is formed by applying one or more of the following to the first substrate: deforming; moulding; embossing; blistering; stamping.

10. A seed storage device according to claim 1 wherein the seed storage device is in the form of a tape with the pods arranged sequentially along the tape.

11. A seed storage device according to claim 10 wherein the tape is wound into a tape reel.

12. A method of planting seeds using a seed storage device according to claim 1, the method comprising:
breaching one of the pods; and
releasing the seeds to a planting location.

13. A method of storing seeds, the method comprising placing one or more seeds into a pod of the seed storage device according to claim 1.

14. A method according to claim 13 wherein each pod is formed by a cavity in a first substrate and a second substrate covering the cavity, the method comprising:
placing one or more seeds into the cavity; and
covering the cavity with the second substrate.

15. A method according to claim 13 wherein each pod is formed by a cavity in a first substrate and a second substrate covering the cavity, the method comprising:
forming the cavity in a first substrate;
placing one or more seeds into the cavity; and
covering the cavity with the second substrate.

16. A method according to claim 14 wherein covering the cavity with the second substrate includes sealing the cavity against an external environment to minimise spoilage of the seeds.

17. A completed seed kit comprising:
a seed storage device according to claim 1; and
one or more seeds stored in one or more of the pods.

18. A smart indoor grow box comprising a completed seed kit according claim 17.
